(19) United States
(12) Patent Application Publication
(10) Pub. No.: US 2010/0239396 A1
(43) Pub. Date: Sep. 23, 2010

(54) ADJUSTABLE REPOSITIONABLE SUPPORT THAT CAN BE LOCKED IN POSITION, AND AN AUTOMATED WORK STATION INCLUDING SUCH A REPOSITIONABLE SUPPORT

(75) Inventor: Bernard Negre, Paris (FR)

Correspondence Address: YOUNG & THOMPSON, 209 Madison Street, Suite 500, Alexandria, VA, 22314, US

(73) Assignee: ABB FRANCE, Rueil Malmaison (FR)

(21) Appl. No.: 12/160,893

(22) PCT Filed: Jan. 19, 2007
(86) PCT No.: PCT/FR2007/000104

§ 371 Date: Jul. 15, 2008

(30) Foreign Application Priority Data
Jan. 19, 2006 (FR) 0600480

(51) Int. Cl. B23Q 1/25; B23Q 7/00; B23Q 3/18

(52) U.S. Cl. 414/222.01; 269/58

(57) ABSTRACT

A repositionable support (1) includes a stationary portion (2) having a movable portion (3) mounted thereon to move in at least one adjustment direction (4) via a link member (5) associated with an actuator for adjusting the position of the movable portion along the adjustment direction, the link member being associated with a member for holding the movable portion in position relative to the stationary portion. A work station including such a support is also disclosed.

The present invention relates to a motor-driven adjustable repositionable support, and to an automatic work station including such a repositionable support.

### BACKGROUND OF THE INVENTION

In general, a work station comprises a main frame having mounted thereon robots together with repositionable supports arranged to engage the workpiece so as to position it accurately relative to the robots or relative to other positioning members forming part of the work station. There exists work stations that are designed to receive workpieces of differing types. Under such circumstances, the repositionable supports used are adjustable repositionable supports. An adjustable repositionable support generally comprises a stationary portion having a movable portion mounted thereon to move along at least one adjustment direction by means of a link member associated with an actuator for adjusting the position of the movable portion along the adjustment direction. The stationary portion is provided with means for fastening it to the main frame of the work station. The link member may be constituted, for example, by an eccentric having the movable portion secured thereto and driven in rotation by a rotary motor constituting the adjustment actuator. The link member may equally well be formed by a slider that is driven in translation by a linear electromagnetic actuator.

In certain work stations, it is necessary to lift the workpiece in order to bring it into a working position. Proposals have been made to use adjustable repositionable supports for lifting the workpiece and holding it in the working position. With workpieces that are relatively heavy, such as motor vehicle bodywork parts, it is necessary for the repositionable support actuator to be sufficiently powerful to be capable of lifting the workpiece and of holding it in the working position, and for the actuator to continue to be powered in order to ensure that the workpiece is held in its working position. Under such circumstances, the actuator not only presents a high level of energy consumption, but it is also bulky, thereby reducing the potential for access to the immediate vicinity of the workpiece. In addition, the cost of an actuator that is both powerful and accurate is relatively high, thereby increasing the cost of work stations, which generally include a plurality of repositionable supports.

### OBJECT OF THE INVENTION

It would therefore be advantageous to have available a repositionable support that does not present the above-mentioned drawbacks.

### SUMMARY OF THE INVENTION

To this end, the invention provides a repositionable support comprising a stationary portion having a movable portion mounted thereon to move along at least one adjustment direction by means of a link member associated with an actuator for adjusting the position of the movable portion along the adjustment direction. The link member is associated with a position-holder member for holding the movable portion mechanically in position relative to the stationary portion, the position-holder member being independent of the actuator.

The position-holder member is independent of the actuator in that the locking that is performed is not performed by the actuator itself and is therefore not the result of the actuator being powered. The locking is mechanical in that the position-holder member opposes an applied force in particular by constituting an obstacle, by jamming, or by friction. Thus, the movable portion is held in position by the position-holder member, and the actuator is stressed little or not at all once the movable element has been locked in position. The position-holding provided by the support that can have its holding position adjusted is much more accurate than the accuracy that can be obtained by continuing to power an actuator.

In a first embodiment, the link member is arranged to enable the movable portion to move relative to the stationary portion in irreversible manner, and the link member preferably comprises a first element and a second element that form a screw-and-nut connection and that are associated respectively with the stationary portion and with the movable portion, the screw-and-nut connection having a pitch that is determined to ensure that movement of either one of the elements relative to the other is irreversible.

The link member then also constitutes means for holding the movable element in position, such that the structure of the repositionable support is particularly simple and reliable.

In second and third embodiments, the position-holder element is a mechanical latch or a friction member, and it is mounted on the stationary portion so as to be engageable against the movable portion.

In these embodiments, the position-holder members are relatively simple.

The invention also provides a work station comprising a main frame, at least one operational unit fastened on the main frame, a conveyor member for conveying a workpiece in the work station, at least one positioning element, and means for causing the workpiece to move relative to the positioning element in a movement direction between a disengagement position in which the positioning element is disengaged from the workpiece, and a working position in which the positioning element co-operates with the workpiece. The positioning element comprises the movable portion of a repositionable support of the above type that is mounted in the work station in such a manner that the adjustment direction extends parallel to the movement direction, the drive means being distinct from the repositionable support, and the repositionable support and the drive means are controlled in such a manner that the repositionable support is locked in position when the drive means reach the working position.

Thus, positioning is provided by a repositionable support of the above-specified type when it is in the holding position, and relative movement between the workpiece and the repositionable support is driven by the drive means. It is thus possible to have a high level of drive force while also benefiting from a high degree of accuracy in position-holding.

In various embodiments:
the work station includes a plurality of repositionable supports, each having its stationary portion secured to a common frame that is connected to the main frame via the drive means;
the drive means comprise a robot having an arm with the stationary element of the repositionable support secured to the free end thereof; and
the stationary portion of the repositionable support is rigidly secured to the main frame and the drive means are associated with the conveyor member, the conveyor member being a robot that also forms the drive member, or the conveyor member is connected to the main frame via the drive means, or indeed the conveyor member comprises a horizontal conveyor supporting a platform on which the workpiece is mounted via the drive means.

Other characteristics and advantages of the invention appear on reading the following description of particular non-limiting embodiments of the invention.

### BRIEF DESCRIPTION OF THE DRAWINGS

Reference is made to the accompanying drawings, in which:

FIG. 1 is a diagrammatic longitudinal section view of a repositionable support in accordance with a first embodiment of the invention;

FIG. 2 is a fragmentary diagrammatic section view of a repositionable support in accordance with a second embodiment of the invention;

FIG. 3 is a view analogous to FIG. 2 showing a third embodiment of the invention;

FIG. 4 is a diagrammatic view of a work station in accordance with a first embodiment of the invention;

FIG. 5 is a diagrammatic view of a work station in accordance with a second embodiment of the invention;

FIG. 6 is a view analogous to FIG. 5 showing a variant of the second embodiment;

FIG. 7 is a diagrammatic view of a work station in accordance with a third embodiment;

FIG. 8 is a diagrammatic view of a work station in accordance with a fourth embodiment; and

FIG. 9 is a fragmentary diagrammatic view of a work station in accordance with a fifth embodiment.

### DETAILED DESCRIPTION OF THE INVENTION

With reference to FIG. 1, the repositionable support in accordance with the first embodiment is given overall reference 1 and comprises a stationary portion 2 that is of tubular shape and that slidably receives a movable portion 3 that is slidable along an adjustment direction 4. The movable portion 3 is prevented from moving in rotation relative to the stationary portion 2.

The repositionable support 1 further comprises a link member given overall reference 5 that extends between the stationary portion 2 and the movable portion 3 and that is associated with an actuator 6. The link member 5 and the actuator 6 in this embodiment are received in the stationary portion 2.

The link member 5 comprises a nut 7 secured to the movable portion 3, and a screw 8 parallel to the adjustment direction 4 and having the nut 7 engaged thereon. The screw 8 is secured to the outlet shaft of a rotary electric motor constituting the actuator 6.

Since the movable portion 3 is prevented from moving in rotation relative to the stationary portion 2, rotating the screw 8 causes the movable portion 3 to move relative to the stationary portion 2. The pitch of the screw 8 and of the nut 7 is determined in such a manner that a force applied to the movable portion 3 parallel to the adjustment direction 4 cannot cause the screw 8 to turn (even when the actuator 6 is unpowered), and therefore cannot lead to the movable portion 3 moving up or down.

Elements that are identical or analogous to those described above are given identical reference numerals in the following description of two other embodiments of the invention.

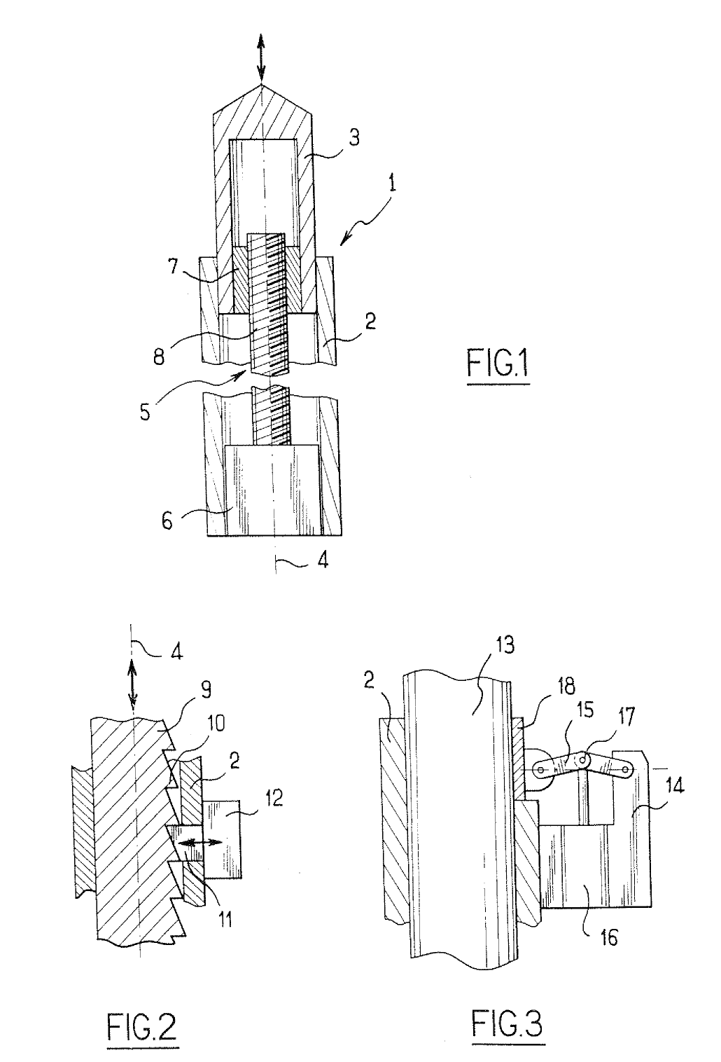

In a second embodiment shown in FIG. 2, the link member 5 comprises a slider 9 having a top end fitted with the movable portion 3 and a bottom end engaged in an actuator 6, in this embodiment a linear electromagnetic actuator.

The slider 9 is provided with teeth 10 of serrated cross-section that co-operate with a mechanical latch 11 mounted on the stationary portion 2 to slide transversely relative thereto between an engagement position in which the mechanical latch 11 projects between two teeth 10, and a retracted position in which the mechanical latch 11 is disengaged from the teeth 10. The mechanical latch 11 is associated firstly with an electromagnetic actuator 12 that is secured to the stationary portion 2 and that moves the mechanical latch 11 from its engagement position to its retracted position, and secondly with a spring (not visible in FIG. 2) that urges the mechanical latch 11 towards its engagement position.

The mechanical latch 11 and the electromagnetic actuator 12 form a position-holder member for holding the movable element 3 in position. It will be understood that when the slider 9 is moved upwards by the actuator 6, the sloping faces of the teeth 10 cause the mechanical latch 11 to move into the retracted position, while the return spring returns the mechanical latch 11 into its position engaged between two teeth 10 as soon as the mechanical latch 11 leaves a tooth 10. The mechanical latch 11 thus acts as a pawl that, when pressed against a radial face of a tooth 10, prevents the slider 9 from moving in reverse. When the slider 9 reaches the desired position, the actuator 6 is turned off and the mechanical latch 11 in the engaged position between two teeth 10 of the slider 9 holds the slider 9 in position. To return the slider 9 to its low position, the electromagnetic actuator 12 is operated to take the mechanical latch 11 into its retracted position, and the actuator 6 is operated to bring the slider 9 down into its low position.

In the third embodiment shown in FIG. 3, the link member 5 comprises a slider 13 having a top end fitted with the movable element 3 and a bottom end secured to the rod of a jack constituting the actuator 6.

The repositionable support 1 has a member for holding the movable element 3 in position. Said member comprises a shoe 18 bearing against the side surface of the slider 13. The shoe 18 is connected by a toggle 15 to a strength member 14 secured to the stationary element 2. The position-holder member further comprises a linear actuator 16 having a moving rod that is connected to the center hinge 17 of the toggle 15 to move the center hinge 17 between a position in which the toggle 15 is folded with the shoe 18 separated from the side surface of the slider 13, and a position in which the toggle 15 jams the shoe 18 against the side surface of the slider 13 (as shown in FIG. 3). It will be understood that in the jamming position, the shoe 18 exerts a transverse force on the lateral surface of the slider 13, holding the slider 13 in position by friction.

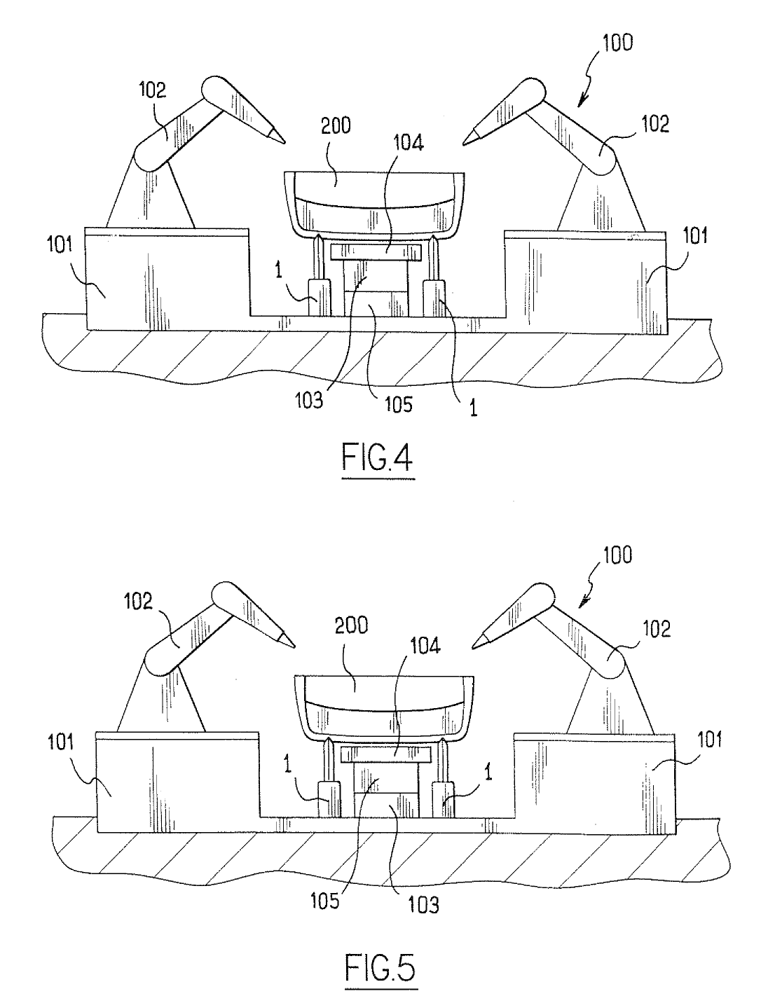

With reference to FIG. 4, a work station in accordance with a first embodiment, given overall reference 100, comprises a main frame 101 having robots 102 mounted thereon with a conveyor member passing between them, the conveyor member comprising a horizontal conveyor 103 supporting platforms 104 that in turn support workpieces 200.

A drive member 105 connects the conveyor 103 to the main frame 101 to lift the conveyor 103 between a high position for conveying purposes and a low position for working purposes. The drive member 105 may be a deployable linkage, e.g. a parallelogram linkage, or it may be telescopic, e.g. a jack.

In the vicinity of the conveyor 103, there are located repositionable supports 1 of the type described in three embodiments above. The stationary portions thereof are secured to the main frame 101 and the adjustment direction 4 is vertical.

On arriving in the work station 100, the platform 104 is supported on the conveyor 103 in its high, conveying position. The repositionable supports 1 are set to the proper position and they are locked in this position.

When the platform 104 is between two robots 102, the lift member 105 brings the conveyor 103 down to the low, working position and the repositionable supports 1 that support the workpiece 200 take the place of the conveyor 103 and of the platform 104.

Once the work has been carried out, in order to put the platform 104 back on the conveyor 103, the lift member 105 lifts the conveyor 103 so that the platform 104 again takes charge of the workpiece 200.

Elements that are identical or analogous to those described above are given identical numerical references in the following description of three other embodiments.

In the second embodiment of FIG. 5, the lift member 105 is interposed between the conveyor 103 and the platform 104.

In a variant, as shown in FIG. 6, the platform 104 is fitted with bearing means 110 for the workpiece 200. These bearing means 110 are formed by repositionable supports analogous to the repositionable supports 1 that enable the conveyor member to be adapted to workpieces of different types.

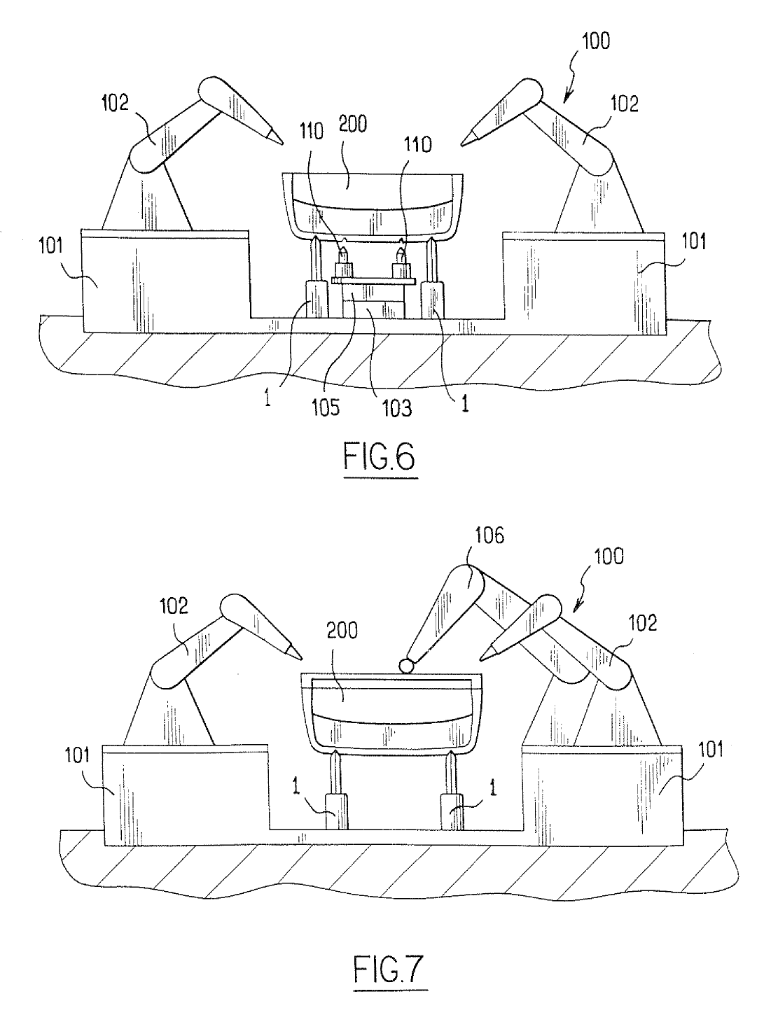

In the third embodiment of FIG. 7, the conveyor member is a robot 106 that brings the workpieces 200 into the work station 100 and that places them on repositionable supports 1 that are set and locked in the proper position. The robot 106 constitutes the member for moving workpieces between the high position for transport purposes and the low position for work purposes.

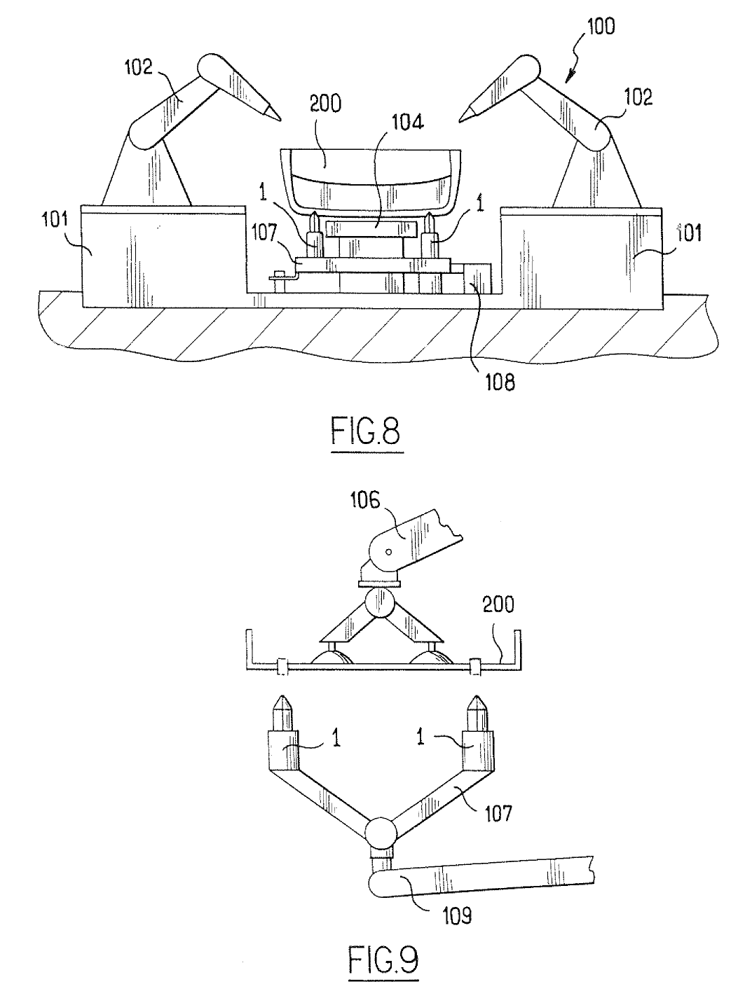

In the fourth embodiment of FIG. 8 the conveyor member 103 is rigidly secured to the main frame 101. The repositionable supports 1 are secured to a movable frame 107 that is connected to the main frame 101 via a drive member 108 that is implemented for example in the form of a telescopic or screw jack, or in the form of a deformable parallelogram.

In the fifth embodiment of FIG. 9, the conveyor member is a robot 106, however it could equally well be a conveyor rigidly secured to the main frame 101. The repositionable supports 1 are secured to a movable frame 107 secured to an arm of the robot 109.

Naturally, the invention is not restricted to the embodiments described and it is possible to apply variations thereto without going beyond the ambit of the position as defined by the claims.

In particular, the actuators, the link members, and the members for holding the repositionable supports 1 in position could be different from those described, for example they could comprise mechanical or hydraulic clamping means, wedging means, or any other means suitable, for holding the movable portion 3 in position relative to the stationary portion 1.

Although for reasons of simplifying the description the repositionable supports described are adjustable in one direction only, provision can be made for the repositionable supports to be adjustable also in other directions. Under such circumstances, the repositionable support may optionally include means for preventing the movable portion from moving in its other directions.

The repositionable support 1 may be of a structure different from those described above, e.g. resulting from combining the embodiments described, and in particular from combining the first and third embodiments, a brake being pressed against the outlet shaft of the motor that is connected to the screw.

In a variant, the conveyor is controlled to cause the platform to perform go-and-return movements in order to bring the workpiece into the work station and take the platform away once the workpiece is supported by the positioning element of the work station.

The term “main frame” is used to mean any structure suitable for supporting operational units, and in particular structures that are secured to the ground, or indeed the ground itself.

1-16. (canceled)

17. A work station (100) comprising a main frame (101), at least one operational unit (102) fastened on the main frame, a conveyor member (103) for conveying a workpiece (200) in the work station, at least one positioning element (3), and means (105) for causing the workpiece to move relative to the positioning element in a movement direction between a disengagement position in which the positioning element is disengaged from the workpiece, and a working position in which the positioning element cooperates with the workpiece, the work station being characterized in that:
the positioning element comprises the movable portion of a repositionable support comprising a stationary portion (2) on which a movable portion (3) is mounted to move in at least one adjustment direction (4) by means of a link member (5) associated with an actuator for adjusting the position of the movable portion along the adjustment direction, the link member being associated with a position-holder member for holding the movable portion mechanically in position relative to the stationary portion, the position-holder member being independent of the actuator, the repositionable support being mounted in the work station in such a manner that the adjustment direction (4) extends parallel to the movement direction;
in that the drive means are distinct from the repositionable support; and
in that the repositionable support and the drive 30 means are controlled in such a manner that the repositionable support is locked in position when the drive means reach the working position.

18. A work station (100) according to claim 17, having a plurality of repositionable supports (1) each having its stationary portion (2) secured to a common frame (107) connected to the main frame (101) via drive means.

19. A work station (100) according to claim 18, in which the drive means comprise a telescopic member.

20. A work station (100) according to claim 17, in which the drive means comprise a robot having an arm (109) with the stationary element (2) of at least one repositionable support (1) fastened to the free end thereof.

21. A work station (100) according to claim 17, in which the stationary portion (2) of the repositionable support (1) is rigidly secured to the main frame (101), and in that the drive means are associated with the conveyor member (103).

22. A work station (100) according to claim 21, in which the conveyor member is a robot (106) also constituting the drive member.

23. A work station (100) according to claim 21, in which the conveyor member (103) is connected to the main frame (101) via drive means.

24. A work station (100) according to claim 21, in which the conveyor member comprises a horizontal conveyor (103) for a platform (104) on which the workpiece is mounted, the drive means (105) being associated with the horizontal conveyor to act directly or indirectly on the platform (104).

25. A work station (100) according to claim 24, in which the drive means (105) are interposed between the horizontal conveyor (103) and the platform (104).

26. A work station (100) according to claim 24, in which the platform (104) is fitted with bearing means (110) for a workpiece, the bearing means comprising repositionable supports.

27. A work station (100) according to claim 26, in which the conveyor is controlled to cause the platform (104) to perform go-and-return movements to bring the workpiece into the work station and to extract the platform therefrom once the workpiece is supported by the positioning element (3) of the work station.

28. A repositionable support according to claim 17, in which the link member (5) is arranged to enable the movable portion (3) to move in irreversible manner relative to the stationary portion (2).

29. A repositionable support according to claim 28, in which the link member (5) comprises a first element (8) and a second element (7) that form a screw-and-nut connection and that are associated respectively with the stationary portion (2) and the movable portion (3), the screw-and-nut connection having a pitch that is determined to ensure that the movement of either element relative to the other is irreversible.

30. A repositionable support according to claim 17, in which the position-holder element is a mechanical latch (11).

31. A repositionable support according to claim 17, in which the position-holder element is a friction member (18) mounted on the stationary portion (2) to be engageable against the movable portion (3).
